(19) United States
(12) Patent Application Publication
(10) Pub. No.: US 2011/0058860 A1
(43) Pub. Date: Mar. 10, 2011

(54) SUPPORT MECHANISM FOR COIL TENSION SPRING

(75) Inventor: Satoshi HIMENO, Shizuoka-ken (JP)

(73) Assignees: Kabushiki Kaisha Toshiba, Tokyo (JP); Toshiba Tec Kabushiki Kaisha, Tokyo (JP)

(21) Appl. No.: 12/876,994

(22) Filed: Sep. 7, 2010

Related U.S. Application Data
(60) Provisional application No. 61/240,529, filed on Sep. 8, 2009.

(51) Int. Cl. G03G 15/20; F16F 1/06

(52) U.S. Cl. 399/323; 267/174

(57) ABSTRACT

A support mechanism includes a coil spring that generates a tensile force, a hook, and a support member. The hook includes a first position extending from the coil spring, an open end, and a second position that is closer to the open end than the first position. The support member includes a first edge facing the first position and a second edge facing the second position. The second edge is convex in a direction away from the first edge, the direction crossing a plane passing through the first edge, the first position, and the second position.

### CROSS-REFERENCE TO RELATED APPLICATION

This application is based upon and claims the benefit of priority from U.S. provisional application 61/240,529, filed on Sep. 8, 2009; the entire contents of which, are incorporated herein by reference.

### FIELD

Embodiments described herein relate generally to support mechanisms for coil tension springs.

### BACKGROUND

A coil tension spring is used to urge a certain member. Such a coil tension spring includes hooks provided at opposite ends thereof, and the hooks engage with respective objects. For example, two openings may be formed in a plate-like member to allow a hook to pass therethrough.

However, the hook may come off when a certain external force is applied to the coil tension spring.

### DESCRIPTION OF THE DRAWINGS

FIG. 1 is a side view illustrating the support mechanism for a coil tension spring in a first embodiment;

FIG. 2 is a cross-sectional view taken along A-A in FIG. 1;

FIG. 3 is a diagram illustrating a hook coming off a support member;

FIG. 4 is a side view illustrating the support mechanism for a coil tension spring in a second embodiment;

FIG. 5 is a cross-sectional view taken along B-B in FIG. 4;

FIG. 6 is a side view illustrating the support mechanism for a coil tension spring in a third embodiment;

FIG. 7 is a cross-sectional view taken along C-C in FIG. 6;

FIG. 8 is a side view illustrating the support mechanism for a coil tension spring in a fourth embodiment;

FIG. 9 is a diagram illustrating the internal structure of an image forming device in a fifth embodiment;

FIG. 10 is an exterior view of a fixing unit in the fifth embodiment;

FIG. 11 is a side view of the fixing unit;

FIG. 12 is an exterior view illustrating the structure around stripping claws in the fifth embodiment; and

FIG. 13 is an exterior view illustrating the support mechanism for a coil tension spring in the fifth embodiment.

### DETAILED DESCRIPTION

A support mechanism in each embodiment includes a coil spring that generates a tensile force, hooks, and support members. Each of the hooks includes a first position extending from the coil spring, an open end, and a second position that is closer to the open end than the first position. Each of the support members includes a first edge facing the first position and a second edge facing the second position.

The second edge is convex in a direction away from the first edge, the direction crossing a plane passing through the first edge, the first position, and the second position.

Hereinafter, the embodiments will be described with reference to the drawings.

### First Embodiment

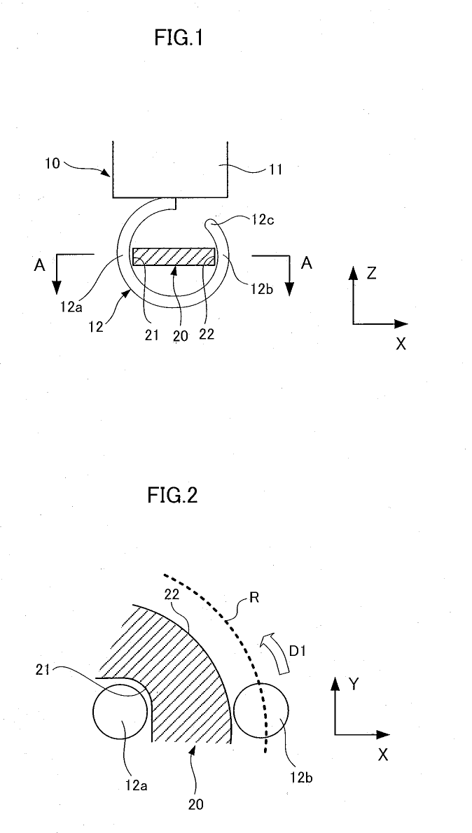

The support mechanism for a coil tension spring in a first embodiment will be described with reference to FIGS. 1 and 2. FIG. 1 is a side view of the support mechanism, and FIG. 2 is a cross-sectional view taken along A-A in FIG. 1. In FIGS. 1 and 2, X-, Y-, and Z-axes are orthogonal to each other.

A coil tension spring 10 includes a coil portion 11 and hooks 12 provided at opposite ends of the coil portion 11. FIGS. 1 and 2 show only one of the hooks. As shown in FIG. 1, the hook 12 has an arc shape. The hook 12 engages with a support member 20.

The support member 20 has a flat planar shape and lies in the X-Y plane. The support member 20 includes a first edge 21 and a second edge 22. The first edge 21 and the second edge 22 are disposed inside the hook 12. The first edge 21 faces a base end portion 12a of the hook 12 in the X-Y plane. The second edge 22 faces a tip end portion 12b of the hook 12 in the X-Y plane and is located closer to the tip end of the hook 12 than the base end portion 12a.

The base end portion 12a and the tip end portion 12b are portions of the hook 12 that overlap with a plane (the X-Y plane) in which the first edge 21 and the second edge 22 lie. The base end portion 12a, the tip end portion 12b, the first edge 21, and the second edge 22 lie in the same plane (the X-Y plane).

As shown in FIG. 2, the first edge 21 has a curvature concave toward the second edge 22 in the X-Y plane and comes into contact with the base end portion 12a of the hook 12. The first edge 21 may not have a curvature. For example, the first edge may be formed of at least two mutually intersecting planes.

The second edge 22 has a curvature convex in a direction away from the first edge 21 in the X-Y plane. The second edge 22 is located at a position that does not overlap with the moving trajectory R of the tip end portion 12b of the hook 12 (see FIG. 2). The moving trajectory R of the tip end portion 12b is a moving trajectory when the tip end portion 12b rotates in the X-Y plane with the base end portion 12a in contact with the first edge 21 serving as a pivot. The trajectory R shown in FIG. 2 is a part of the moving trajectory of the tip end portion 12b.

An opening or a part of a notch formed in the support member 20 may be used as the first edge 21. Similarly, an opening or a part of a notch formed in the support member 20 may be used as the second edge. One opening may have the first edge 21 and the second edge 22.

It is sufficient to provide the shapes of the first edge 21 and the second edge 22 shown in FIG. 2.

When an external force is applied to the coil tension spring 10, the base end portion 12a may come into contact with the first edge 21, and the tip end portion 12b may rotate in the X-Y plane with the base end portion 12a serving as a pivot. For example, the tip end portion 12b may move in the direction of arrow D1 in FIG. 2.

The second edge 22 is off the moving trajectory R of the tip end portion 12b, and therefore the tip end portion 12b does not collide with the second edge 22. The tip end (opening end) 12c of the hook 12 does not ride over the second edge 22 unless the hook 12 collides with the second edge 22.

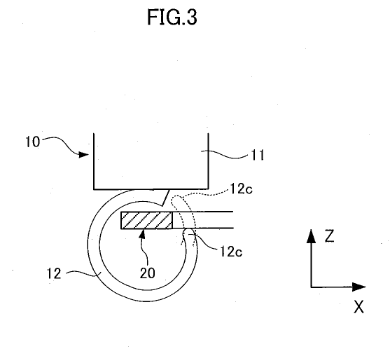

Assuming that the hook 12 can collide with the edge of the support member 20, then the deformation of the hook 12 can cause the tip end 12c of the hook 12 to ride over the edge of the support member 20 and then come into contact with the lower surface of the support member 20. FIG. 3 shows the tip end 12c of the hook 12 that is in contact with the lower surface 20a of the support member 20. The dotted line shown in FIG. 3 illustrates the tip end 12c before the tip end 12c rides over the edge. If the tip end 12c of the hook 12 comes into contact with the lower surface 20a of the support member 20, the hook 12 easily comes off the support member 20.

In this embodiment, since the tip end portion 12b of the hook 12 does not collides with the second edge 22, the tip end 12c of the hook 12 is prevented from riding over the second edge 22. The hook 12 can be prevented from coming off even when the hook 12 does not have a complicated shape.

The hook on the other side of the coil tension spring 10 may be designed similarly.

The first edge 21 and the second edge 22 may have surfaces other than curved surfaces. The first edge 21 and the second edge 22 may have a plurality of flat surfaces.

The first edge 21 and the second edge 22 may not lie in the same plane. The first edge 21 and the second edge 22 may be displaced relative to each other in the Z direction.

### Second Embodiment

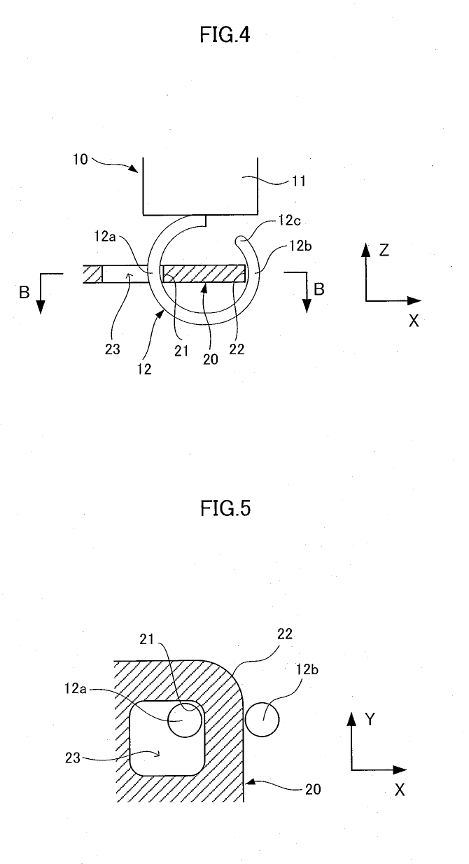

The support mechanism for a coil tension spring in a second embodiment will be described with reference to FIGS. 4 and 5. FIG. 4 is a side view of the support mechanism, and FIG. 5 is a cross-sectional view taken along B-B in FIG. 4. The components described in the first embodiment are denoted by the same numerals, and the detailed description thereof will be omitted.

In this embodiment, a support member 20 has an opening 23. The first edge 21 is a part of the opening 23. The hook 12 passes through the opening 23, and the base end portion 12a is disposed inside the opening 23.

### Third Embodiment

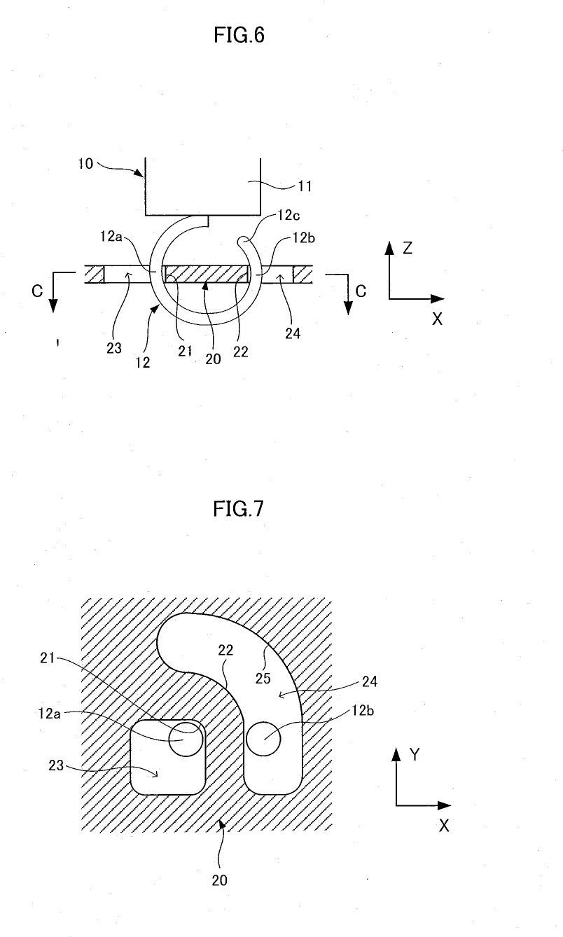

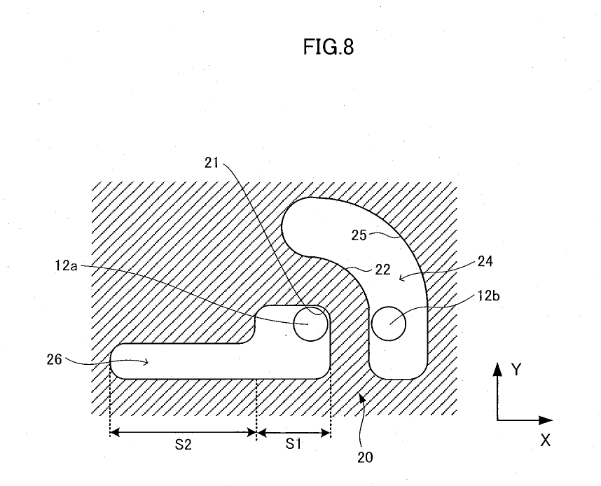

The support mechanism for a coil tension spring in a third embodiment will be described with reference to FIGS. 6 and 7. FIG. 6 is a side view of the support mechanism, and FIG. 7 is a cross-sectional view taken along C-C in FIG. 6. The components described in the first and second embodiments are denoted by the same numerals, and the detailed description thereof will be omitted.

In this embodiment, a support member 20 has openings 23 and 24. The first edge 21 is a part of the opening 23. The second edge 22 is a part of the opening 24. The opening 24 has a third edge 25 that faces the second edge 22. The third edge 25 extends in a direction along the second edge 22. The spacing between the second edge 22 and the third edge 25 is greater than the thickness of the hook 12.

The third edge 25 may not extend along the second edge 22. It is sufficient that the third edge 25 allow the displacement of the tip end portion 12b when the hook 12 receives an external force.

### Fourth Embodiment

The support mechanism for a coil tension spring in a fourth embodiment will be described with reference to FIG. 8. FIG. 8 is a side view of the support mechanism and corresponds to FIG. 7. The components described in the first to third embodiments are denoted by the same numerals, and the detailed description thereof will be omitted.

A support member 20 has the opening 24 and an opening 26. The first edge 21 is a part of the opening 26. The opening 26 has a first region S1 corresponding to the opening 23 in the third embodiment and a second region S2 extending in the X-direction. The second region S2 extends from the first region S1 in a direction away from the opening 24 (the second edge 22).

Since the opening 26 has the second region S2, the hook 12 can be easily inserted into the opening 26. More specifically, by inserting the hook 12 along the second region S2, the hook 12 can be easily inserted into the opening 26. Preferably, the maximum length of the opening 26 in the X-direction (the total length of the first region S1 and the second region S2) is greater than the maximum width of the hook 12.

The length of the first region S1 in the Y direction is greater than the length of the second region S2 in the Y direction, and therefore the base end portion 12a of the hook 12 can stay in the first region S1.

### Fifth Embodiment

A description will be given of a fixing unit including the support mechanisms in the fourth embodiment and of an image forming device including the fixing unit.

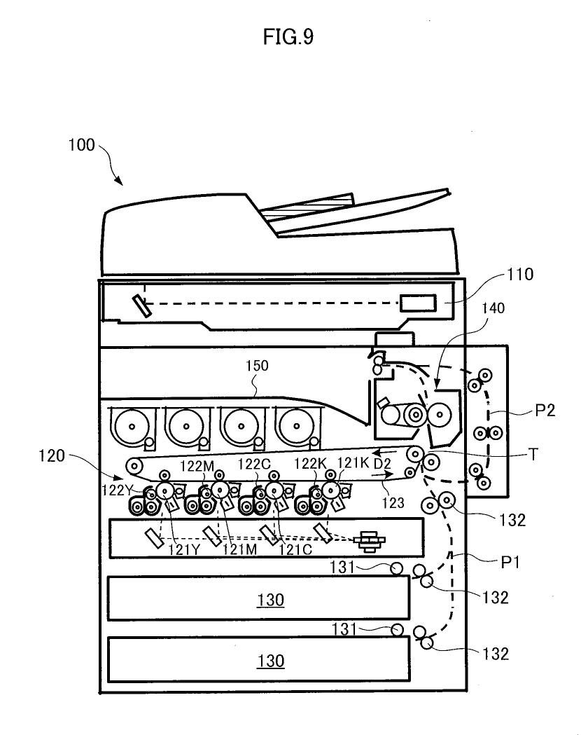

The image forming device in this embodiment will be described with reference to FIG. 9. As shown in FIG. 9, the image forming device 100 includes an image reading unit 110 and an image forming unit 120.

The image reading unit 110 scans and reads an image of a sheet manuscript or a book manuscript. The image forming unit 120 forms a tonner image on a sheet from image data generated by the reading operation of the image reading unit 110, from image data sent from an external device (such as a personal computer) to the image forming device 100, or from other data.

The outline of copy processing will be described as an example of the processing in the image forming device 100.

A pick-up roller 131 picks up a sheet in a paper feed cassette 130, and the picked-up sheet travels along a conveying path P1. A plurality of rollers 132 are disposed in the conveying path P1, and the sheet is conveyed by the rotation of the plurality of rollers 132.

The image forming unit 120 forms electrostatic latent images on the photosensitive surfaces of photosensitive drums 121Y, 121M, 121C, and 121K according to the image data generated by the reading operation of the image reading unit 110. The photosensitive drums 121Y to 121K are used to transfer yellow (Y), magenta (M), cyan (C), and black (K) toner images onto the sheet, respectively.

Developing rollers (so-called mag rollers) 122Y, 122M, 122C, and 122K supply toner to the photosensitive drums 121Y to 121K having the electrostatic latent images formed thereon to develop the electrostatic latent images formed on the photosensitive surfaces of the photosensitive drums 121Y to 121K into visible images. The photosensitive drums 121Y to 121K transfer the tonner images formed on the photosensitive surfaces to an intermediate transfer belt 123 (so-called primary transfer). The intermediate transfer belt 123 rotates in the direction of arrow D2 to convey the tonner images and transfers the tonner images on the intermediate transfer belt 123 to the sheet at a secondary transfer position T.

The paper sheer having the transferred toner image travels to a fixing unit 140, and the fixing unit 140 heats the sheet to fix the toner image onto the sheet. The sheet having the fixed toner image travels in the conveying path P1 by a plurality of rollers and is delivered to a tray 150. A sheet conveying path P2 is a path configured to turn upside down a sheet.

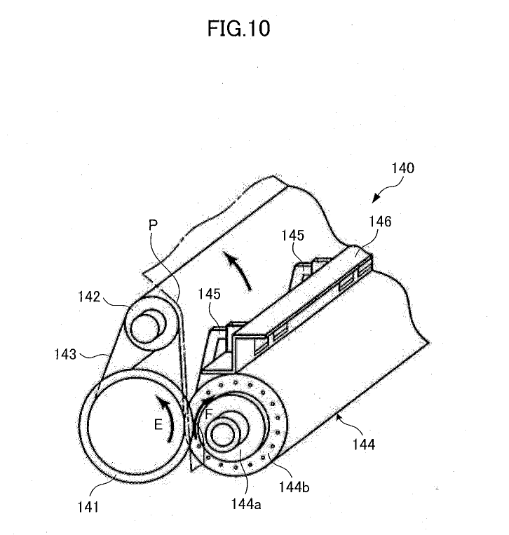

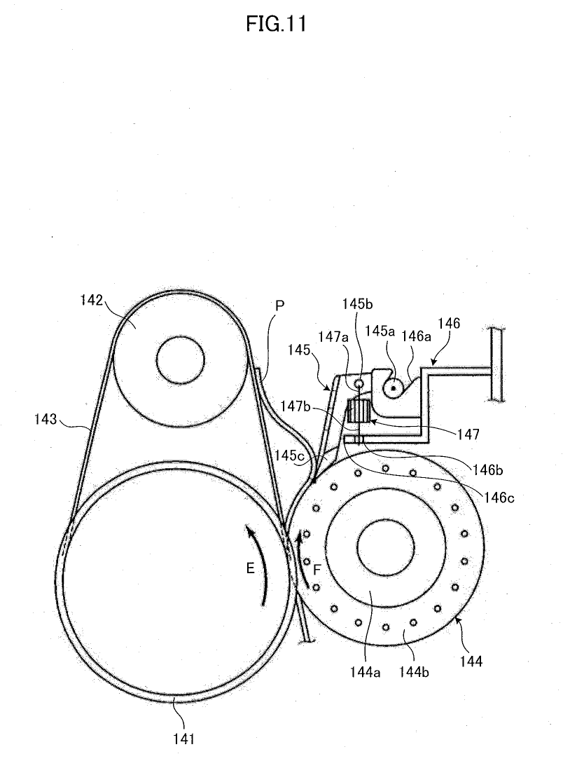

The fixing unit 140 will be described with reference to FIGS. 10 and 11. FIG. 10 is an exterior view of the fixing unit 140, and FIG. 11 is a side view of the fixing unit 140.

A heating roller 141 heats a sheet P. The heating roller 141 rotates in the direction of arrow E. A sub-roller 142 disposed above the heating roller 141 has a diameter smaller than the diameter of the heating roller 141.

The heating roller 141 and the sub-roller 142 support a belt 143. Since the rotation of the heating roller 141 is transmitted to the sub-roller 142 through the belt 143, the sub-roller 142 rotates together with the heating roller 141.

A press roller 144 presses the heating roller 141. The press roller 144 includes a rotation shaft 144a and an elastic member 144b that covers the outer circumference of the rotation shaft 144a. The elastic member 144b may be formed of, for example, synthetic resin sponge. The press roller 144 rotates in the direction of arrow F.

A plurality of stripping claws 145 strip the sheet P off from the press roller 144. The stripping claws 145 are arranged in the direction of the rotation axis of the press roller 144.

A support member 146 is disposed above the press roller 144 and supports the stripping claws 145. Each of the stripping claws 145 includes a shaft portion 145a and rotates about the shaft portion 145a. The rotation axis of each stripping claw 145 is disposed along the rotation axis of the press roller 144.

The support member 146 has notches 146a supporting the shaft portions 145a. The shaft portions 145a can move along the notches 146a. When an external force is applied to the stripping claws 145, the shaft portions 145a can move along the notches 146a.

First hooks 147a on one ends of coil tension springs 147 engage with openings 145b of the stripping claws 145. Second hooks 147b on the other ends of the coil tension springs 147 engage with support portions 146b of the support member 146. Each support portion 146b has the openings 24 and 26 described in the fourth embodiments.

The coil tension springs 147 generate forces for pressing the ends 145c of the stripping claws 145 against the press roller 144. The coil tension springs 147 are disposed closer to the conveying path of the sheet P than the shaft portions 145a of the stripping claws 145.

Stoppers 146c of the support member 146 come into contact with the stripping claws 145 so as to prevent the ends 145c of the stripping claws 145 from pressing the press roller 144 more than necessary.

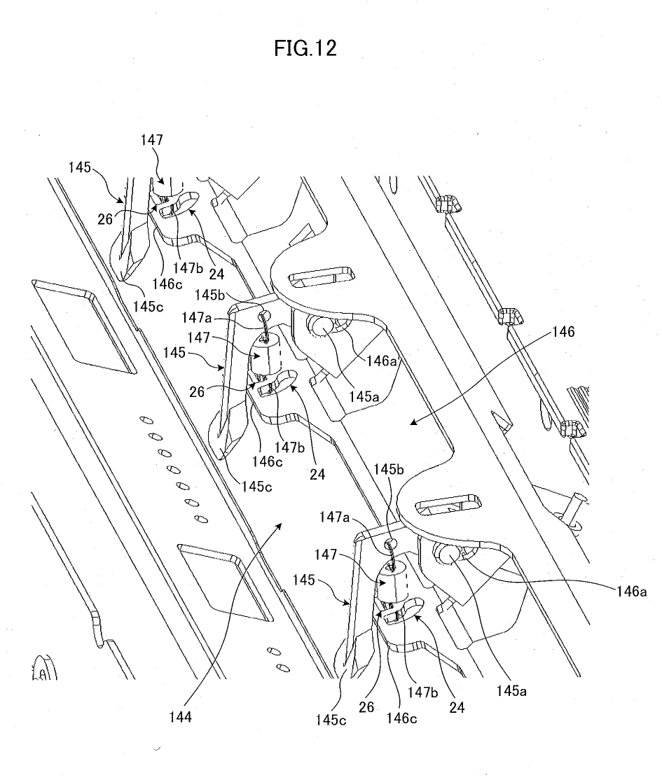

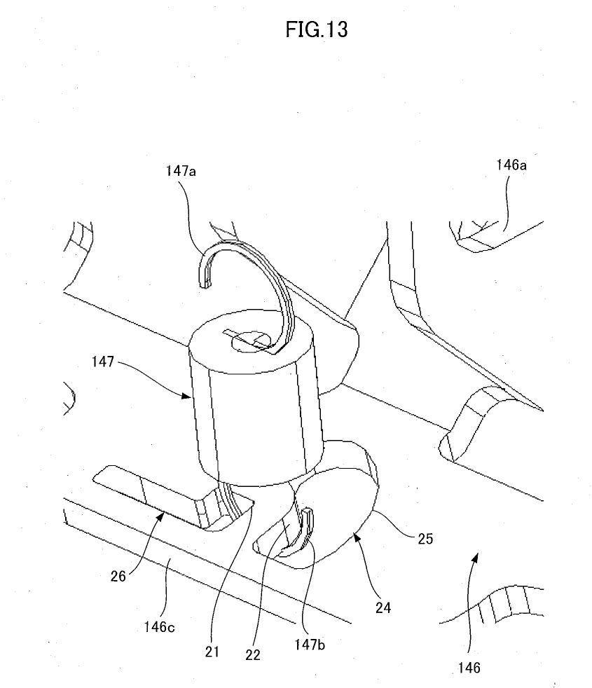

FIGS. 12 and 13 are enlarged views illustrating portions around the stripping claws 145.

The support member 146 has the openings 24 and 26 described in the fourth embodiment. As shown in FIGS. 11 and 12, the support portions 146b (the openings 24 and 26) are disposed on the side opposite to the conveying path of the sheet P with respect to the stripping claws 145. The openings 24 extend in the direction away from the conveying path of the sheet P.

When the sheet P is jammed in the fixing unit 140, the jammed sheet must be removed. During the removal of the sheet P, an external force may be applied to the coil tension springs 147. As described in the fourth embodiment, even when such an external force is applied to the coil tension springs 147, the second hooks 147b are prevented from coming off the openings 24.

A description will be given of the operation of the fixing unit 140.

When a sheet P passes through the nip portion between the heating roller 141 and the press roller 144, a toner image is fixed onto the sheet P. The belt 143 guides the sheet P after fixing to the sub-roller 142. The sheet P is stripped off from the belt 143 near the top portion of the sub-roller 142.

Even when the sheet P sticks to the press roller 144, the ends 145b of the stripping claws 145 enter between the sheet P and the press roller 144 as shown in FIG. 11, so that the sheet P is stripped off from the press roller 144.

In this embodiment, the number of the stripping claws 145 may be one or more. The stripping claws 145 may strip a sheet P off from the heating roller 141 or the sub-roller 142. The stripping claws 145 may strip a sheet P off from at least one of the heating roller 141, the sub-roller 142, and the press roller 144. The sub-roller 142 and the belt 143 may be omitted.

While certain embodiments have been described, these embodiments have been presented by way of example only, and are not intended to limit the scope of invention. Indeed, the novel mechanisms and methods described herein may be embodied in a variety of other forms; furthermore, various omissions, substitutions and changes in the form of the mechanisms and methods described herein may be made without departing from the spirit of the inventions. The accompanying claims and their equivalents are intended to cover such forms or modifications as would fall within the scope and spirit of the inventions.

What is claimed is:

1. A support mechanism, comprising:
a coil spring that generates a tensile force;
a hook that includes a first position extending from the coil spring, an open end, and a second position closer to the open end than the first position; and
a support member that includes a first edge facing the first position and a second edge facing the second position, the second edge being convex in a direction away from the first edge, the direction crossing a plane passing through the first edge, the first position, and the second position.

2. The support mechanism according to claim 1, wherein the first edge is concave toward the second edge in a plane including the first edge.

3. The support mechanism according to claim 1, wherein the second edge is closer to the first position than a moving trajectory in which the second position rotates about the first position.

4. The support mechanism according to claim 3, wherein the second edge is parallel to the moving trajectory.

5. The support mechanism according to claim 1, wherein the hook passes through an opening formed by the first edge.

6. The support mechanism according to claim 5, wherein the first edge extends in a direction away from the second edge.

7. The support mechanism according to claim 1, wherein the hook passes through an opening formed by the second edge.

8. The support mechanism according to claim 5, wherein the second edge forms the opening together with the first edge.

9. A fixing unit, comprising:
a roller used to fix a toner image onto a sheet;
a claw configured to separate the sheet from the roller;
a coil spring configured to generate a tensile force on the claw;
a hook that includes a first position extending from the coil spring, an open end, and a second position closer to the open end than the first position; and
a support member that includes a first edge facing the first position and a second edge facing the second position, the second edge being convex in a direction away from the first edge, the direction crossing a plane passing through the first edge, the first position, and the second position.

10. The fixing unit according to claim 9, wherein the first edge is concave toward the second edge in a plane including the first edge.

11. The fixing unit according to claim 9, wherein the second edge is closer to the first position than a moving trajectory in which the second position rotates about the first position.

12. The fixing unit according to claim 11, wherein the second edge is parallel to the moving trajectory.

13. The fixing unit according to claim 9, wherein:
the claw rotates about an axis parallel to a rotation axis of the roller; and
the coil spring is closer to a conveying path of the sheet passing through the roller than the rotation axis of the claw.

14. The fixing unit according to claim 13, wherein the second edge extends in a direction away from the conveying path.

15. The fixing unit according to claim 9, wherein the hook passes through an opening formed by the first edge.

16. The fixing unit according to claim 9, wherein the hook passes through an opening formed by the second edge.

17. The fixing unit according to claim 15, wherein the second edge forms the opening together with the first edge.

18. The fixing unit according to claim 9, wherein a plurality of claws are arranged in the rotation axis of the roller.

19. The fixing unit according to claim 9, further comprising a heating roller that generates heat to fix the toner image onto the sheet, and wherein
the roller is a press roller configured to press the sheet against the heating roller.

20. A method for strip, comprising:
heating a sheet and a toner image on the sheet by a heater;
stripping the sheet off from the heater by a claw that is pressed against the roller by a support mechanism comprising a coil spring that generates a tensile force, a hook that includes a first position extending from the coil spring and an open end and a second position closer to the open end than the first position, and a support member that includes a first edge facing the first position and a second edge facing the second position, the second edge being convex in a direction away from the first edge, the direction crossing a plane passing through the first edge, the first position, and the second position.
